(19) United States
(12) Patent Application Publication
(10) Pub. No.: US 2017/0134806 A1
(43) Pub. Date: May 11, 2017

(54) SELECTING CONTENT BASED ON MEDIA DETECTED IN ENVIRONMENT

(71) Applicant: AXWAVE INC., Palo Alto, CA (US)

(72) Inventors: DAMIAN ARIEL SCAVO, Palo Alto, CA (US); Loris D'Acunto, Palo Alto, CA (US)

(21) Appl. No.: 15/247,397

(22) Filed: Aug. 25, 2016

Related U.S. Application Data
(63) Continuation of application No. 14/695,811, filed on Apr. 24, 2015, now abandoned.
(60) Provisional application No. 61/983,992, filed on Apr. 24, 2014.

(51) Int. Cl. H04N 21/458; H04N 21/442; H04N 21/81; H04N 21/44; H04N 21/45; H04N 21/439; H04N 21/433

(52) U.S. Cl. CPC H04N 21/458; H04N 21/4394; H04N 21/442; H04N 21/4331; H04N 21/44008; H04N 21/4532; H04N 21/812

(57) ABSTRACT

Techniques to select content based on ambient media detection are disclosed. In various embodiments, a received set of audio features associated with an audio environment and a stored media signature data are used to detect, based at least in part on the set of audio features, a media channel and program that is being played in the audio environment. Stored data associating one or more advertising or other classification codes with the detected media channel and program is used to determine an advertising or other classification code. The determined advertising or other classification codes to select and provide to a target device associated with the audio environment a secondary content.

### CROSS REFERENCE TO OTHER APPLICATIONS

This application is a continuation of U.S. patent application Ser. No. 14/695,811, filed Apr. 24, 2015 and claims priority to U.S. Provisional Patent Application No. 61/983,992, filed Apr. 24, 2014, both entitled SELECT CONTENT BASED ON MEDIA DETECTED IN ENVIRONMENT which is incorporated herein by reference for all purposes.

### BACKGROUND OF THE INVENTION

Users often consume media, such a live or on demand TV broadcast or other media content, in an environment (e.g., a room in their home or office) in which one or more devices are available for their use. For example, a TV show may be playing in a room in which one or more viewers each has access to a mobile phone, tablet, or other mobile device; a personal computer (PC), laptop, or other computing device; a smart TV or other “smart” consumer electronic device; etc. In current approaches, typically a user's experience with respect to such other devices has been distinct from the media being consumed in the environment.

Techniques are known to provide online advertising and other electronic content based on context, e.g., location, time of day, the content of a page or other content within which the advertising or other content is to be displayed, etc., and based on information determined to be (more likely to be) of interest to a user, based on, for example, a user profile, pages or other content the user has viewed recently, items the user has viewed on shopping sites, topics the user has mentioned in social media posts, etc. However, typically the information used to select such content is based on prior activities of the user and/or context information intrinsic to and available directly from the device to which advertising or other content is being selected to be provided.

### BRIEF DESCRIPTION OF THE DRAWINGS

Various embodiments of the invention are disclosed in the following detailed description and the accompanying drawings.

FIG. 1 is a block diagram illustrating an embodiment of a system to detect ambient media.

FIG. 2 is a flow chart illustrating an embodiment of a process to provide content related to detected media.

FIG. 3 is a flow chart illustrating an embodiment of a process to associate advertising or other classification codes with a specific TV or other media content stream capable of being rendered in an audio environment.

FIG. 4 is a flow chart illustrating an embodiment of a process to detect that a particular TV or other media content stream is being rendered in an audio environment.

FIG. 5 is a flow chart illustrating an embodiment of a process to determine topics associated with a TV or other media content stream.

FIG. 6 is a block diagram illustrating an embodiment of a system to select and provide content associated with detected ambient media.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Selecting content, for example an ad, to be provided to a device based at least in part on a media content, such as a TV program or commercial, that has been determined using the device to be playing in an environment in which the device is located, is disclosed. In various embodiments, a main or other topic associated with the media content being played in the environment may be determined, e.g., through backend processing of the media stream, and used to select content to be provided to the device, such as an ad.

In some embodiments, advertisement codes (e.g., IAB codes, Mobile rich media ad interface, etc.) may be determined to be related to TV and Media topics, and that relationship used to associate advertisement codes with the content currently being played, e.g., in a local area in which the device is located, by a channel the content of which has been recognized to be playing in the audio environment in which the device is located. The advertisement codes may then be used, in some embodiments along with other information (e.g., user profile, past user behavior, etc.), to select ads or other content to be served to the device.

For example, a user may be determined, using techniques described herein, to be watching a particular cable or other TV channel and the main topic being discussed on the show currently being broadcast on that channel may have been determined through processing of the media stream currently being broadcast by that channel, to be Green Energy. In various embodiments, an ad or other content would be selected to be served to a device located in the environment in which the detected TV channel is being played, such as the device used to detect that the media channel is being played, based at least in part on the main topic being discussed on the TV program currently being broadcast on that channel. For example, in the case of program about Green Energy, an ad for an electric or other “green” car may be provided.

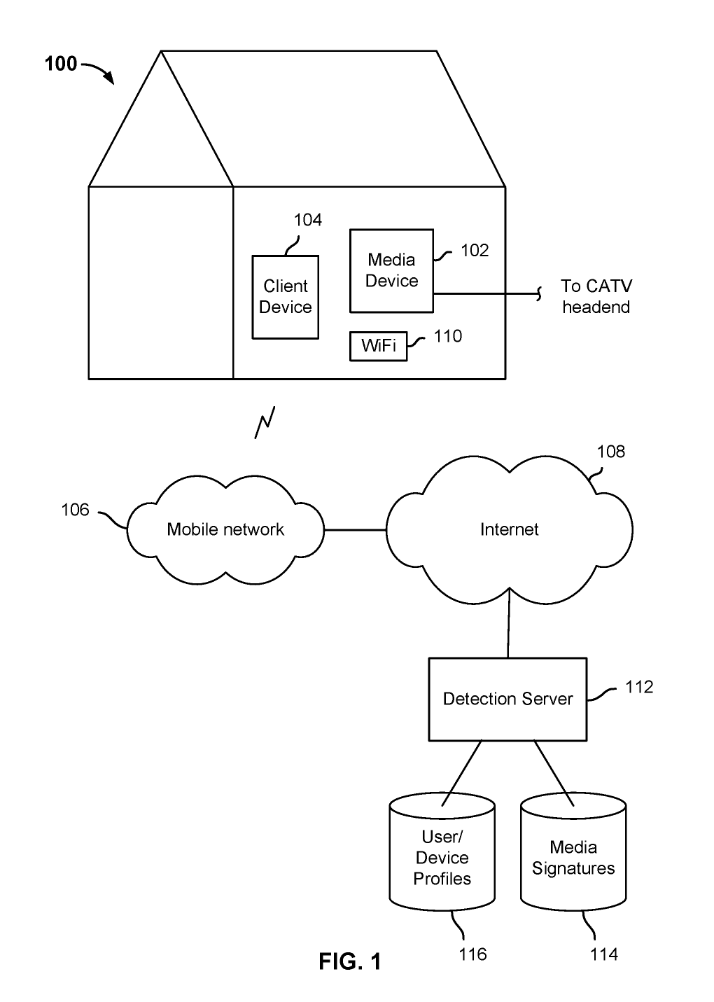

FIG. 1 is a block diagram illustrating an embodiment of a system to detect ambient media. In the example shown, an ambient media detection system and environment 100 includes a media device 102, in this example a TV or other display device connected to a cable television (CATV) head end (or other audiovisual media distribution node). A client device 104 configured to detect media in an environment in which the client device 104 is located is present in the same location. In the example shown, the client device 104 is shown as a device separate from media device 102, but in various embodiments the client device 104 may be included in and/or the same as media device 102. Examples of media device 102, in various embodiments, include without limitation a “smart” TV or other media display device having a network connection and processor; a media player device; a gaming console, system, or device having a display and/or speakers; a home theater system; an audio and/or video component system; a home desktop or other computer; a portable device, such as a tablet or other smart device usable to play audiovisual content; etc. Examples of client device 104, in various embodiments, include without limitation one or more of the foregoing examples of media device 102 and/or any other device having or capable of being configured to include and/or receive input from a microphone, a processor, and a network or other communication interface, e.g., a cable TV decoder or other connectivity device (e.g., separate from a TV or other display); a gaming console, system, or device; a home desktop or other computer; a portable device, such as a tablet or mobile phone; etc.

In the example shown in FIG. 1, the client device 104 is configured to monitor an ambient audio environment in a location in which the client device 104 is present. In various embodiments, the client device 104 may be configured to monitor the ambient audio environment by accessing and using a microphone comprising and/or connected to client device 104. The client device 104 may be configured to execute software code, such as a mobile or other application and/or code incorporated into such an application, e.g., using a software development kit (SDK), or other techniques, to perform TV or other media content detection as disclosed herein.

In various embodiments, client device 104 is configured to sample the ambient environment to determine if conditions are present to enable media detection to be performed. For example, the client device 104 may determine whether an ambient sound level in proximity of the client device 104 is sufficiently high to perform media detection, whether characteristics possibly associated with media content are detected, etc. In some embodiments, client device 104 may be configured to attempt to perform media detection only at configured and/or configurable times, e.g., certain times of day, different times of day depending on the day of the week, on days/times learned over time to be times when the client device 104 may be in an environment in which media is being played (e.g., user often watches TV on weekday evenings but rarely during the workday, etc.), etc.

In the example shown in FIG. 1, client device 104 sends audio data and/or a representation thereof, such as a “feature” set extracted and/or otherwise determined from the ambient audio environment, via a wireless connection to an associated mobile network 106, which provides access to the Internet 108. In some embodiments, a WiFi access node, such as WiFi access node 110 in the example shown, may be used by client device 104. In various embodiments, any Internet or other network access (e.g., cable, mobile) may be used. However the connection to the Internet 108 is made, client device 104 uses the connection to send audio data and/or a representation thereof to a remote detection server 112.

Detection server 112 uses media content signatures in a media signatures database (or other data store) 114 to determine if data received from client device 114 matches known media content. For example, in some embodiments, media signatures 114 may include for each of a plurality of cable TV or other broadcast channels a corresponding set of “feature sets” each of which is associated with a media content and/or portion thereof that is being, was, and/or is expected to be broadcast (or otherwise provided, e.g., streamed, etc.), e.g., at an associated time of a given day. For example, a backend process not shown in FIG. 1 may be used to receive and process a stream or other set of media content data and associated times (e.g., timestamps) at which respective portions of the content have been and/or will be broadcast, streamed, etc.

In various embodiments, detection server 112 may be configured to determine based on data received from the client device 104 and the media signatures 114 that a particular cable or other TV channel is being viewed at the location in which the client device 104 sampled the ambient audio environment. In some embodiments, the detected channel and/or information determined based at least in part thereon may be communicated to one or more of the client device 104 and the media device 102. For example, advertising or other content associate with a program being broadcast on a cable channel that has been detected in the ambient audio environment may be served to the client device 104. In the example shown, detection server 112 may be configured to update one or more profiles associated with a user, a device (e.g., media device 102 and/or client device 104), and/or a location (e.g., one associated with media device 102 and/or client device 104, and/or determined based on a GPS or other location service of client device 104) may be updated in a user/device profiles database 116.

In various embodiments, user, device, and/or location profiles stored in profiles database 116 may include one or more of user profile data that was provided explicitly by and/or inferred about a user; historical data indicating which media channels have been detected in a given environment and/or by a given client device and at which times and days of the week, etc.; records of content or other data provide to a user, location, and/or device based at least in part on media channel and/or content detection, etc.

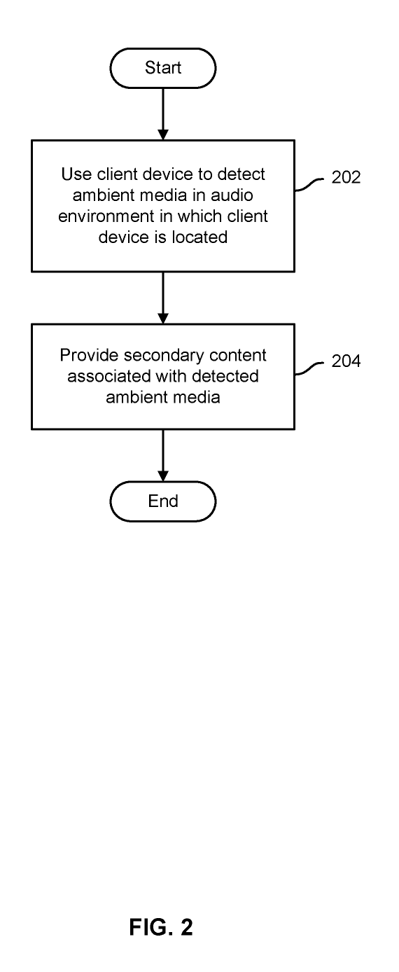

FIG. 2 is a flow chart illustrating an embodiment of a process to provide content related to detected media. In various embodiments, the process of FIG. 2 may be implemented by one or more client devices, e.g., client device 104 of FIG. 1, in communication and cooperation with one or more servers, e.g., detection server 112 of FIG. 1. In the example shown, a client device is used to detect ambient media in an audio (or other sensory) environment in which the client device is located (202). The client device may, in various embodiments, be configured to extract a feature set or other representation from ambient audio (or other) data and to send the feature set or other representation, and/or data derived therefrom, to a remote detection server. The server may be configured to receive and process feature sets or other representations received from respective clients. Secondary content associated with the detected audio (or other media) environment is provided (204). For example, the server may be configured to detect based on the received feature set that a media channel, e.g., that a given cable TV channel, is being viewed or otherwise rendered at a location in which the client is located. Based on the foregoing determination, the server may be configured to select related secondary content (e.g., advertising content, games, trivia questions, etc.) and provide the secondary content via an appropriate delivery channel, e.g., via the device being used to view the media channel and/or the device (if separate) used to detect the media environment.

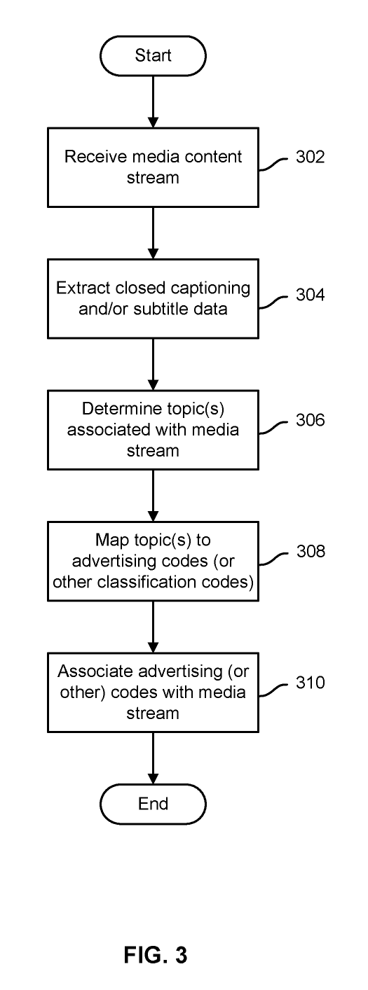

FIG. 3 is a flow chart illustrating an embodiment of a process to associate advertising or other classification codes with a specific TV or other media content stream capable of being rendered in an audio environment. In various embodiments, the process of FIG. 3 may be performed by a backend server configured to receive a TV or other media stream and determine one or more topics, classification codes, labels, or other index values to be associated with the media stream as being indicative of a main semantic content of the stream and/or a portion thereof. In various embodiments, the process of FIG. 3 may be used to build an index or other knowledge store that may be used to select and provide content related to the main topic(s) of a media stream to a device determined to be located in an environment in which the indexed media stream is being played.

In the example shown, a media content stream is received (302). For example, a media content stream may be received at the same time or a short time before the same stream is received at one or more distribution nodes used to broadcast or otherwise provide the stream to end user devices, such as a cable TV head end. Data comprising a text-based representation of the content of the media stream, e.g., closed captioning data, subtitles, dynamically generated audio-to-text data, etc., is extracted (304).

Language processing techniques are used to determine one or more topic(s) with which the media stream or at least the most recently received portion thereof is/are associated (306). In some embodiments, the stream of words extracted from the media stream is divided in overlapping continuous chunks of strings. Every single chunk includes enough words to be used to identify a correct temporary topic, e.g., using indexing algorithms with semantic analysis. The topics identified are ordered by importance and saved in a database with associated information, such as the TV or other channel ID with which the media stream is associated and a timestamp, e.g., indicating a location within the stream of a portion of the stream with which the topic has been determined to be associated. In some embodiments, a set of main topics is developed over time, as more and more of the media stream is received and processed, and additionally topics associated more particularly with specific portions of the media stream, e.g., the last minute or two, may be maintained. In this way, secondary content more specifically relevant to the portion of media content that has just been broadcast may be selected to be provided.

Topics determined to be associated with the media stream are mapped to one or more suitable ad codes (for example IAB codes) and/or other classification codes (308). In some embodiments, classification systems (e.g., deep neural networks) may be used to map the words of the topics and the advertising categorization codes (e.g., IAB Codes: IAB1: Entertainment, IAB17 Sports, IAB17-2: Baseball, etc.). Data associating the identified advertising (or other classification) codes with the corresponding media stream and/or portions thereof is saved (310) and made available to be used to select and provide secondary content, such as ads, to a device determined to be in a location in which the TV or other media stream is being played.

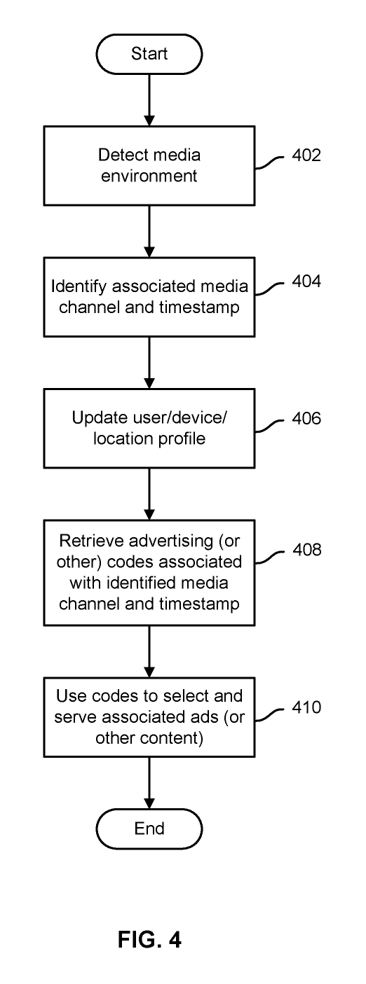

FIG. 4 is a flow chart illustrating an embodiment of a process to detect that a particular TV or other media content stream is being rendered in an audio environment. In various embodiments, the process of FIG. 4 may be performed by one or more backend servers. For example, in some embodiments, all or part of the process of FIG. 4 may be performed by a detection server, such as detection server 112 of FIG. 1.

In the example shown in FIG. 4, a media environment is detected (402). For example, a client device equipped with TV or other audio content recognition technology may open a session with a remote detection server and may extract audio features from the ambient audio environment and send the features to the remote server to be used to identify the TV or other media channel is being played in the local environment. For example, an app running on a mobile phone or other device may be equipped to listen to the environment, extract audio features from the audio environment, and provide the features and/or a representation thereof to a server to perform TV recognition, for example by matching the extracted features to a corresponding fingerprint of a program known to be being played on a specific TV channel at that same time.

The server identifies the channel, the program, and the relative timestamp (404). The identified information is stored in a database, e.g., in a user, device, and/or location profile or other data structure (406). Advertising or other classification codes corresponding to the media channel and program that have been detected as being played are retrieved according to the channel and the timestamp (408). For example, the process of FIG. 3 may have been used as described above to determine and store advertising codes for the program being played by the detected media channel at that time.

A relevant ad or other secondary content is selected based on the retrieved advertising or other classification code(s) and provided in real-time, such as immediately and/or in response to a next ad request, e.g., from an app running on the device used to recognize the media channel (410).

In various embodiments, data may be saved reflecting the observed viewing habits of a specific user (and/or device and/or location). Such data may be used in the future to select and serve content that may be more relevant for that user. For example, if a user who has been determined to be watching a football game currently was observed previously to be watching a Trivia Game Show on TV, the service may select and provide a trivia question about football, or the ads selected to be provided to fulfill ad requests from the trivia game app may be ads about football.

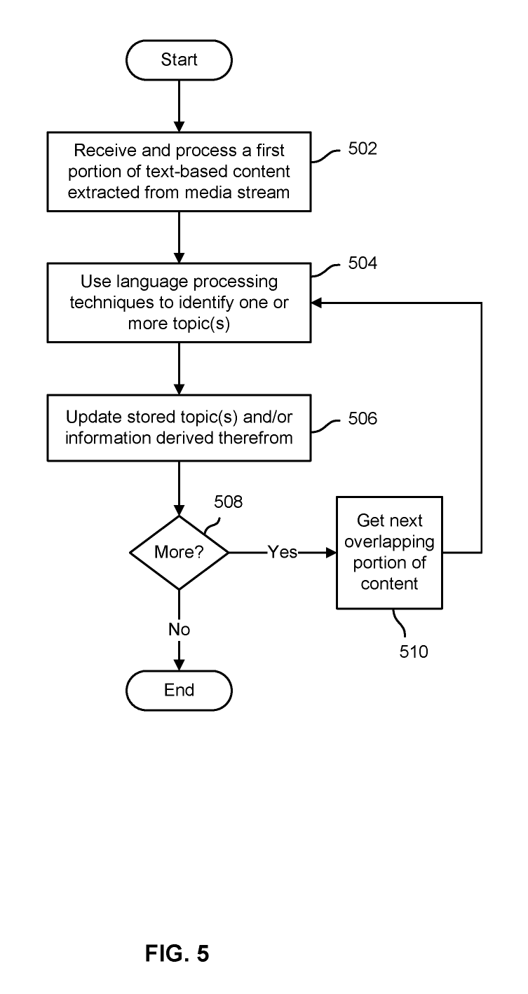

FIG. 5 is a flow chart illustrating an embodiment of a process to determine topics associated with a TV or other media content stream. In some embodiments, the process of FIG. 5 may be used to determine topics based on text-based information extracted from a media stream. A first portion of text-based content is extracted from the media stream (502). For example, a segment of text comprising a prescribed, configured, and/or configurable number of words may be processed as a segment. Language processing techniques are used to identify one or more topic(s) as being associated with the portion of text (504). In some embodiments, the topic(s) identified for a portion of text may be used to update and/or weight or score a set of main topic(s) being determined for the media stream (e.g., TV program) as a whole and/or to associated specific topic(s) with a corresponding particular portion of the media stream, e.g., a most recently broadcast minute or other portion of the broadcast. Topic(s) as stored for the media stream and/or the corresponding portion thereof are updated (506). If there is more content to be processed (508) a next overlapping portion of text-based content (i.e., overlapping with the portion just processed) is obtained (510) and processed to associate topics with that portion and/or all or some defined part of the media stream (502, 504, 506). Processing continues until the entire broadcast stream has been processed (508).

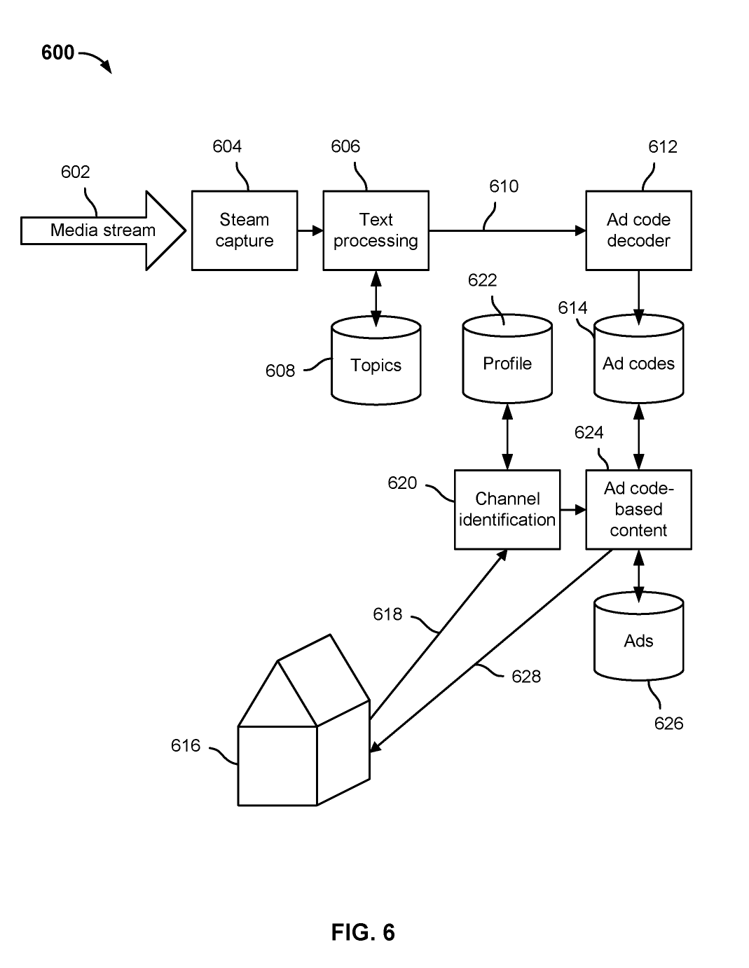

FIG. 6 is a block diagram illustrating an embodiment of a system to select and provide content associated with detected ambient media. In various embodiments, elements of the system of FIG. 6 may be used to determine advertising (e.g., IAB) codes automatically for TV or other media content, e.g., using the process of FIG. 3, and to use the determined codes and other information to select ads (or other content) to be provided, e.g., to a device determined to be in an environment in which the media content for which IAB codes have been determined is being played, e.g., as in FIG. 4.

In the example shown, in the system 600 a media stream 602 is received by a stream capture module, system, and/or process 604 and provided to a text processing module 606. The text processing module may comprise a software code running on a server or other computer and/or special purpose hardware, such as an ASIC. In various embodiments, one or both of the stream capture module 604 and the text processing module 606 may extract text-based content from the media stream 602, e.g., closed captioning data, subtitles, and/or audio-to-text processing. The text-based content is processed to determine one or more topic(s) associated with the text-based content, e.g., from a set of topic(s) and associated language processing based parameters as stored in a topics database 608. The resulting determined topic(s) and data identifying the media stream (e.g., channel, program) and/or portions thereof (e.g., timestamp, offset) are provided as output 610 to an advertising (or other classification) code decoder 612. Decoder 612 maps the topics to ad codes and stored in ad code index/database 614 data associating the determined ad codes with the corresponding media stream and/or portion thereof.

In various embodiments, media stream 602 may be received substantially concurrently with the broadcast of the media stream by a given media channel. For example, media stream 602 may be received at or near the same time as the same media stream is being provided to distribution nodes for delivery to end users, e.g., via a cable TV head end or other distribution node.

A client device (not shown) located at a physical location 616 listens to the ambient audio environment, extracts audio features, and send the features 618 to channel identification module, system, component, and/or process 620, e.g., a process or module running on a detection server, such as detection server 112 of FIG. 1. The channel identification module 620 may use profile data from a profile database 622 to assist in channel detection, e.g., a history of channels previously detected as being consumed by the same user. The channel identification module 620 determines, based on the feature set and/or other information, that a specific media channel is being played in the location 616 in sufficient proximity to the device that provided the feature set 618 to be detected. The channel identification data may be used to update an associated profile in profile database 622. The channel identification module provides the detected media channel information to an ad code-based content server, process, module, etc. 624. The ad code-based content server 624 retrieves from ad code database 614 one or more ad codes associated with the detected media channel, program, and/or portion thereof and uses the retrieved ad codes to select from ad source(s) 626 and serve to a target device at location 616 a targeted ad or other content 628. In various embodiments, the target device may be the client device that provided the feature set 618 and/or a media player (e.g., TV) associated with displaying the media content at the location 616.

In some embodiments, the ad code-based content server 624 may use user profile information store in profile database 622 to select an ad or other content. For example, in some embodiments, the feature set 618 may be received from an app on a client device located at location 616 and which is associated with an identifier that has been mapped to a particular user. In some embodiments, a user may use social network service credentials (e.g., Facebook, etc.) to sign in to the app that provided the feature set 618, enabling topics determined to be potentially of interest to the user, e.g., based on the social network posts, newsfeeds, pages visited and/or commented on, etc. to be considered, along with dynamically detected media and associated information, to select advertising or other content for viewer. For example, if a main topic of a detected media content is “green energy” and the user's profile indicates a recent interest in content associated with search to buy a new car, the ad server 624 may in some embodiments be more likely to serve an ad for an energy efficient car than an ad for a service that installs solar panels on homes, even though both may be associated with the same or related advertising codes associated with clean or “green” energy.

In various embodiments, techniques disclosed herein may be used to provide advertising or other content to users, e.g., via a client device, based at least in part on detection that a specific media channel and/or program is being played in an ambient environment in which the client device is located.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method to select content based on ambient media detection, comprising:
using a processor, a received set of audio features associated with an audio environment, and a stored media signature data to detect, based at least in part on the set of audio features, a media channel and program that is being played in the audio environment;
using the processor and stored data associating one or more advertising or other classification codes with the detected media channel and program to determine an advertising or other classification code; and
using the processor and the determined advertising or other classification codes to select and provide to a target device associated with the audio environment a secondary content.

2. The method of claim 1, wherein the stored media signature data is generated and stored in or near real time as a media stream associated with the detected media channel and program is being distributed via one or more distribution nodes to consumers of the media channel.

3. The method of claim 2, wherein the stored media signature data is generated at least in part by extracting from the media stream a media stream feature set corresponding to the feature set associated with the audio environment.

4. The method of claim 1, wherein the stored data associating one or more advertising or other classification codes with the detected media channel and program is generated and stored in or near real time as a media stream associated with the detected media channel and program is being distributed via one or more distribution nodes to consumers of the media channel.

5. The method of claim 4, wherein the stored data associating one or more advertising or other classification codes with the detected media channel and program is generated at least in part by extracting text-based content from the media stream.

6. The method of claim 5, wherein extracting text-based content from the media stream includes extracting one or more of closed caption, subtitle, or other text-based content from the media stream.

7. The method of claim 5, wherein the text-based content is processed to determine one or more topics with which the media stream is associated.

8. The method of claim 7, wherein the one or more topics are used to determine said one or more advertising or other classification codes.

9. The method of claim 1, wherein the target device comprises a client device that provided the set of audio features associated with the audio environment.

10. The method of claim 9, wherein the secondary content comprises advertising content.

11. The method of claim 9, wherein the secondary content comprises application content.

12. The method of claim 11, wherein the application content is associated with an application used to extract and provide said set of audio features associated with the audio environment.

13. The method of claim 1, wherein the secondary content is selected based at least in part on a user profile data.

14. A system to select content based on ambient media detection, comprising:
a communication interface; and
is a processor coupled to the communication interface and configured to:
use a received set of audio features associated with an audio environment and a stored media signature data to detect, based at least in part on the set of audio features, a media channel and program that is being played in the audio environment;
use stored data associating one or more advertising or other classification codes with the detected media channel and program to determine an advertising or other classification code; and
use the determined advertising or other classification codes to select and provide to a target device associated with the audio environment a secondary content.

15. The system of claim 14, wherein the stored media signature data is generated and stored in or near real time as a media stream associated with the detected media channel and program is being distributed via one or more distribution nodes to consumers of the media channel.

16. The system of claim 15, wherein the stored media signature data is generated at least in part by extracting from the media stream a media stream feature set corresponding to the feature set associated with the audio environment.

17. The system of claim 14, wherein the stored data associating one or more advertising or other classification codes with the detected media channel and program is generated and stored in or near real time as a media stream associated with the detected media channel and program is being distributed via one or more distribution nodes to consumers of the media channel.

18. The system of claim 17, wherein the stored data associating one or more advertising or other classification codes with the detected media channel and program is generated at least in part by extracting text-based content from the media stream.

19. The system of claim 18, wherein extracting text-based content from the media stream includes extracting one or more of closed caption, subtitle, or other text-based content from the media stream.

20. A computer program product to select content based on ambient media detection, the computer program product being embodied in a non-transitory computer readable storage medium and comprising computer instructions for:
using a processor, a received set of audio features associated with an audio environment, and a stored media signature data to detect, based at least in part on the set of audio features, a media channel and program that is being played in the audio environment;
using the processor and stored data associating one or more advertising or other classification codes with the detected media channel and program to determine an advertising or other classification code; and
using the processor and the determined advertising or other classification codes to select and provide to a target device associated with the audio environment a secondary content.
